(19) United States
(12) Patent Application Publication
(10) Pub. No.: US 2024/0141580 A1
(43) Pub. Date: May 2, 2024

(54) DRYER APPARATUS

(71) Applicant: Hedgehog AS, Hemsedal (NO)

(72) Inventors: Bjørn Holte, Hemsedal (NO); Magne Tveit Bolstad, Volda (NO)

(73) Assignee: Hedgehog AS, Hemsedal (NO)

(21) Appl. No.: 18/548,446

(22) PCT Filed: Mar. 2, 2022
(86) PCT No.: PCT/NO22/50054

§ 371 Date: Aug. 30, 2023

(30) Foreign Application Priority Data
Mar. 3, 2021 (NO) 20210284
Apr. 8, 2021 (NO) 20210426

(51) Int. Cl. D06F 59/02

(52) U.S. Cl. CPC D06F 59/02

(57) ABSTRACT

A dryer assembly is for drying garments, the dryer assembly having: a housing with an air inlet and an outlet; a centrifugal impeller for generating a flow of air from the inlet to the outlet, the centrifugal impeller having backwardly curved blades and being adapted to draw in air through the inlet in a direction parallel its rotational axis and to distribute the air radially out into an internal chamber of the housing, the chamber being formed so as to guide the air radially from the impeller towards the outlet, a control unit adapted to control the impeller based on input from a user; and an adapter having an inlet connected to the outlet of the housing and one or more outlets through which air from the dryer housing may flow to dry garment placed around, at or near the outlet, the adapter being releasably connected to the housing.

### CROSS-REFERENCE TO RELATED APPLICATIONS

This application is the U.S. national stage application of International Application PCT/NO2022/050054, filed Mar. 2, 2022, which international application was published on Sep. 9, 2022, as International Publication WO 2022/186697 in the English language. The International Application claims priority of Norwegian Patent Application Nos. 20210284, filed Mar. 3, 2021 and 20210426, filed Apr. 8, 2021. The international application and Norwegian applications are all incorporated herein by reference, in entirety.

### FIELD

The present invention relates to a dryer assembly. More specifically the invention relates to a dryer assembly including a housing with an air inlet and an outlet, the outlet being connectable to an adapter for distributing the air; the drying assembly further including a centrifugal impeller in the housing for generating a flow or air from the inlet to the outlet; and a control unit for controlling the impeller, and optionally a ceramic heating element, based on input from a user.

### BACKGROUND

Efficient drying, storing and sanitizing of shoes, boots, mittens, gloves, etc. is a challenge. Dryers according to the prior art often have short drying cycles, low airflow and insufficient heat to dry shoes, gloves, etc. quickly and efficiently. The main drawback with current dryers is low air pressure, which means that the flow of air from the fan/impeller does not effectively blow into or through the garment, such as shoe or mitten, that it is intended to dry since it stops from the resistance at the intersection between the dryer and the garment. Attempts have been made to increase the airflow and air pressure in dryer apparatuses. This, however, has resulted in unacceptably high is noise levels. Another drawback found in some household dryer apparatuses according to the prior art is that mostly hose-based solutions have been available for bringing air to the garments/items that are to be dried, which is not practical for organizing and storing such items. Although the hose-based solutions may be adequate for shoes or boots, they cannot be used with other garments like moist or wet gloves, mittens, and clothes. Many dryers according to the prior art only offer drying at a fixed temperature with a binary on/off solution not taking into account that different types of garments may need to be dried at different temperatures. As an example, when drying leather gloves or shoes, the temperature should not be more than 37 degrees or sometimes even close to room temperature, while fast efficient drying of other garments may take place at 60 degrees or more. Further, bacteria and odour are a common problem with mittens and shoes, and is also not solved by current dryer systems. Bacteria thrive in moist and wet environments like boots and gloves. Yet another drawback with dryers according to the prior art is that they primarily use coil-based heating elements, which constitute a fire hazard, causing multiple house fires each year. Another drawback with conventional dryers is that un-used outlets still consume air.

CN 212560837 U discloses a dryer apparatus to which a shoe 5 dryer hose is attached.

### SUMMARY

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

The invention relates more specifically to a dryer assembly for drying garments, the dryer assembly comprising:
a housing with an air inlet and an outlet;
a centrifugal impeller for generating a flow of air from the inlet to the outlet, the centrifugal impeller having backwardly curved blades and being adapted to draw in air through the inlet in a direction parallel its rotational axis and to distribute the air radially out into an internal chamber of the housing, the chamber being formed so as to guide the air radially from the impeller towards the outlet,
a control unit adapted to control the impeller based on input from a user; and
an adapter (44) having an inlet connected to the outlet of the housing and one or more outlets through which air from the dryer housing may flow to dry garment placed around, at or near the outlet. In one embodiment the adapter may be releasably connected to the housing, whereby different types of adapters may be used together with the same fan housing, thereby improving flexibility and enabling optimised drying of different types of garments with one and the same fan housing.

The dryer assembly may also include a ceramic heating element provided between the inlet and the outlet of the housing so that heated air may flow out from the housing and into the adapter However, in a simple embodiment, the dryer apparatus may simply be operating at room temperature, whereby no additional heating may be needed.

By the control unit being adapted to “regulate”, the control unit may at minimum switch on/off the assembly, either manually, timer-based and/or based on closed loop feedback on parameters such as temperature, pressure, and airflow. In one embodiment, the control unit may be adapted to switch off the dryer assembly if sensing an increased back-pressure in case of a full or partial blocking of one or more outlets. The control unit may also be used to set the heating element to different temperatures.

Conventional dryer assemblies, such as shoe dryers, normally use forwardly curved blades in their impellers, which generally produce higher airflows. Another benefit with these forwardly curved blade impellers is that they may operate at low speeds resulting in a low noise level. As such, using forwardly curved blades have been the obvious choice for such impellers. The present applicant has surprisingly found that once such dryer systems are exposed to pressure resistance, such as a shoe or a mitten placed over an outlet for drying, the performance/air flow drops drastically, significantly reducing the drying effect.

The use of backwardly curved blades in the impeller generates higher output pressures. By carefully optimizing the rotational frequency of the impeller, the present applicant has found that it is possible to deliver high airflows at high pressures while avoiding unacceptable noise levels.

Compared to dryers according to the prior art, the present dryer assembly generates a higher airflow at a higher pressure. With high air pressure the dryer will “push” the air into the fabric/garment of the item being dried and force the humidity out much more efficiently than previously known dryers.

The use of ceramic heating elements generally improves fire-safety by preventing over-heating in general. In addition, electronic power supply and other electronic components may be coated with fire-resistant gel to prevent electric arcs that can cause fires. In one embodiment, the ceramic heating element may be of the PTC (“positive thermal coefficient”) type, whereby a separate temperature controller for individual heating elements may not be needed. Still, as will be discussed below, temperature feedback from the outlet may be used to activate other or additional heating elements to maintain the output temperature at a desired level.

Different types of garments may require different temperature solutions; for example, leather and form-fit foam in ski boots may need a low temperature, ideally 37 degrees Celsius or room temperature during drying. In one embodiment, it may therefore be possible to set, via the control unit, the ceramic heating element to different power outputs, corresponding to different temperatures of the outlet air. Setpoints may e.g. be 37, 45 and/or 60 degrees. In one embodiment, the different setpoints may be reached by providing the dryer assembly with two or more ceramic heating elements arranged in parallel. In one embodiment, the dryer assembly may be provided with two ceramic heating elements arranged side-by-side or on top of each other, where either one or both heating elements may be activated to define three different temperature setpoints. This may include one small/low effect heating element for low temperature, a second high effect heating element for medium temperature and combining the first and second heating elements for a high temperature.

In one embodiment, the dryer assembly may be provided with a timer, e.g. 12 or 24 hours, so users can better customize drying time without restarting the timer.

In one embodiment, the dryer assembly may be provided with an ozonator that help remove both bacteria and odours by generating small quantities of ozone. In addition, or as an alternative, the dryer apparatus may be provided with an UV light source, typically near, but upstream of the outlet as an additional or alternative means for removing bacteria.

As an alternative or addition to an ozonator and/or UV light source, the dryer assembly may be provided with an air ioniser/ionic air cleaner to (further) improve removal of bacteria and other particles from the air. The air ioniser may be provided near, but upstream the outlet as an additional or alternative means for removing bacteria and other particles from the air.

They control unit may be provided with an adjustable timer so that the user can set the dryer time accordingly to the item being dried, such as long drying circles on low heat or shorter drying cycles on high heat. It may also turn the device off automatically when time ends.

The dryer assembly includes the possibility to mount and connect different drying adapters such as racks that can be wall mounted, or hung from a clothing rod, as well as different adapters such as hoses for drying boots, for drying clothes and tree structured racks for drying smaller items such as gloves and shoes.

The dryer may be provided with a control panel that can be rotated so the dryer/housing can be mounted on the top and bottom of the drying rack so the buttons and icons can be read the correct way.

The impeller may be driven by means of a brush-less direct current (BLDC) motor. BLDC motors may be made compact and durable and can run at very high rotational frequencies (RPM), much higher than motors operating directly from AC current. The dryer apparatus may typically then include an electronic power supply to transform and rectify incoming AC current e.g. as disclosed in GB 2357378 B to which reference is made for an in-depth disclosure of such electronic power supplies for centrifugal fans driven by BLDC motors from incoming AC current. The electronic power supply may be provided with fuses to prevent over-heaiting and fires.

As will be explained herein, the adapter may be provided in a variety of different forms implying that one and the same dryer/housing may be used together with different adapters. Some adapters may be intended to be placed on a floor, mounted to a wall, hanging like a coat hanger etc. The one or more outlets on the adapter may be formed in a rigid/stiff part of the adapter or the one or more outlets may be flexible, such as by the outlets being provided as hoses that may be stretched, bended, extended etc. to fit into shoes and boots. The hoses may be retracted to original size for compact storage.

In one embodiment, the adapter may be a tree-like structure, where the trunk of the tree defines an inlet on the adapter that is connected, directly or indirectly, to the outlet on the housing. Branches on the tree may include the one or more outlets where the garments to be dried may be hung on the branches so that they cover the outlets. In one embodiment each branch may be formed as a straight part with extending outwardly from the trunk and with one outlet at its distal end. In another embodiment, one or more branches may be formed with “sub-branches” splitting into several outlets such as by one or more branches being Y-shaped, whereby more garments may be dried and/or whereby individual garments may be dried more efficiently, such as by the thumb of a mitten being placed over one sub-branch. In yet another embodiment, one or more branches may be extendible, such as by being formed as a telescopic rod, whereby large garments may be placed on the extended branch. In one embodiment, one or more branches may be L-shaped to better adapted to the shape of a shoe that is to be dried.

In one embodiment, a central flow path in the adapter may be formed with 3-5 times, preferably around 4 times, the diameter of an outlet part connected to the central flow path. This has been shown to be particularly useful for maintaining a high flow of air through the adapter while maintaining sufficient pressure and avoiding noise effects. In one specific embodiment, where the adapter is a tree-like structure, the trunk may be formed with an internal diameter of 3-5 times, ideally around 4 times, that of the branches. In one specific embodiment, the trunk is formed with an inner diameter of about 40 mm, while the branches are formed with a diameter of about 10 mm. The adapter may be formed with two or more outlets, such as three, four or even more outlets. The tree-like adapter may be formed with 6, 8, 10 or even 12 or more branches including an outlet each, whereby a corresponding number of garments may be dried at the same time.

In one embodiment, the adapter may be provided with a hook in one end, so that it may be hung in at a wall, in a closet or similar. In another embodiment, the adapter may be mounted on a wall. The dryer may be provided at a top or bottom portion of the adapter. When provided at a top portion, this may be useful to avoid small children from reaching the control panel on the dryer/housing.

In one embodiment, the housing may be connected to an adapter in the form of a coat hanger into which air from the dryer apparatus may flow freely for quick and efficient drying of clothes such as shirts, jackets, etc through outlets in the coat hanger. The coat hanger and garment may be covered by a storage/dress bag having openings allowing air to pass through.

In one embodiment, one or more outlets on the adapter may be provided with a closing mechanism, such as a valve, to close it when it is not in use, whereby airflow through remaining/open outlets may be optimized.

In one embodiment, the adapter may be modular in the sense that further outlets parts may be added to or removed from the adapter while still maintaining its functionality. If the adapter is a tree-like structure, trunk portions/adapter units with one or more branches may be added to or removed from an already installed trunk portion to extend or shorten the adapter/tree.

The dryer apparatus according to the invention may be used together with different adapters at different times, whereby one and the same dryer apparatus may e.g. be released from a coat hanger or tree-based solution to dry shoes with flexible hoses.

### BRIEF DESCRIPTION OF THE DRAWINGS

In the following described examples of preferred embodiments illustrated in the accompanying drawings, wherein:

FIG. 1 shows, in a perspective view, a dryer apparatus according to the present invention;

FIG. 2 shows an enlarged view of the control panel from FIG. 1;

FIG. 3 shows, in a partially cut-away view, a dryer assembly according to the invention;

FIG. 4 shows a schematic view of a fan as used in a dryer apparatus according to the invention;

FIG. 5 shows a schematic view of a fan as used in a dryer apparatus according to the prior art;

FIG. 6 shows a first embodiment of a dryer assembly according to the invention;

FIG. 7 shows a second embodiment of a dryer assembly according to the invention;

FIG. 8 shows a third embodiment of a dryer assembly according to the invention;

FIG. 9 shows a fourth embodiment of a dryer assembly according to the invention;

FIG. 10 shows in a perspective view an impeller as used in a drying apparatus according to the invention;

FIGS. 11-12 show, in a schematic top view, the impeller from FIG. 10; and

FIGS. 13-15 show, in exploded views, dryer assemblies according to the invention.

### DETAILED DESCRIPTION OF THE DRAWINGS

In the following the reference numeral 1 will be used to denote a dryer, whereas reference numeral 10 refers to a dryer assembly according to the invention. The drawings are shown schematic and simplified, and various features therein are not necessarily drawn to scale.

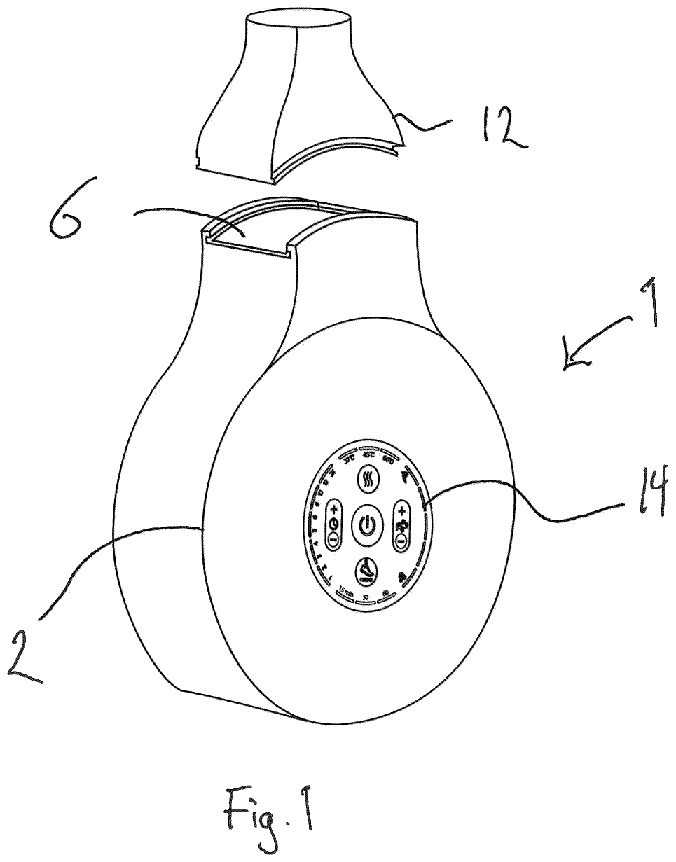

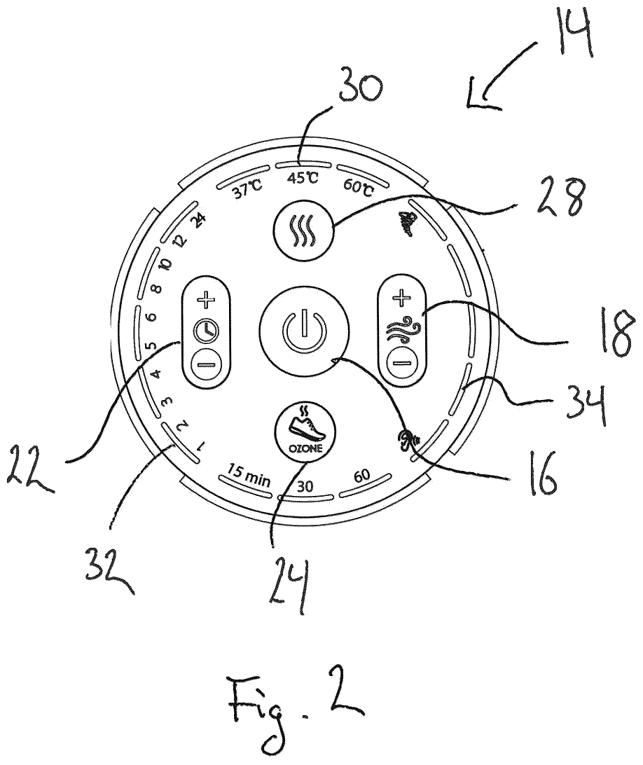

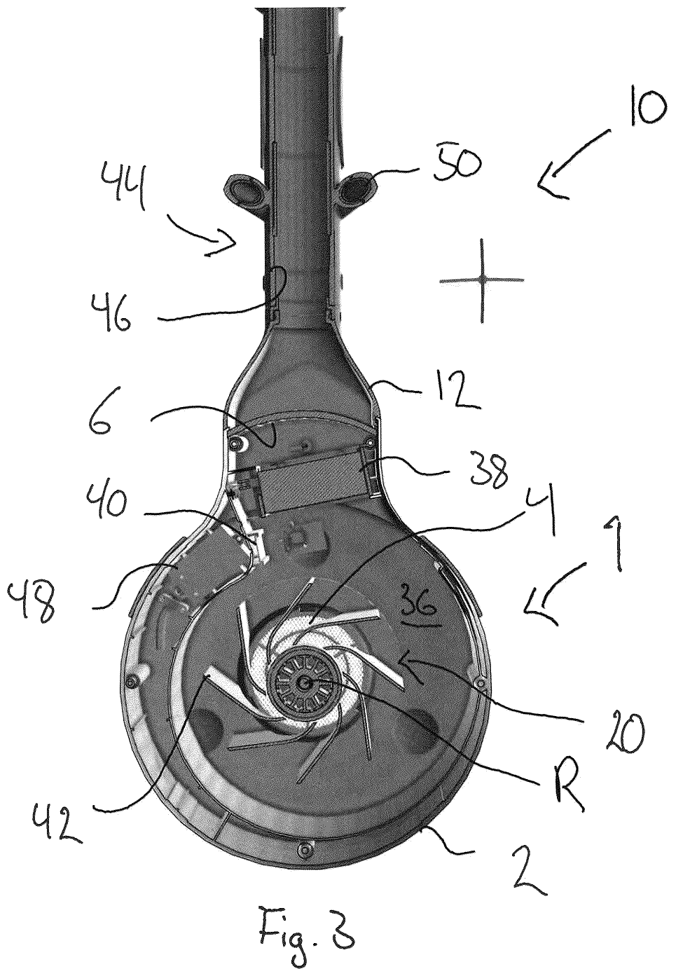

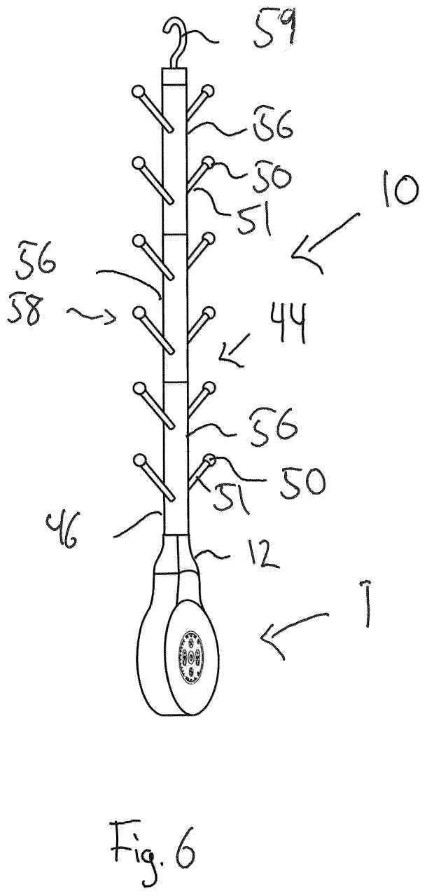

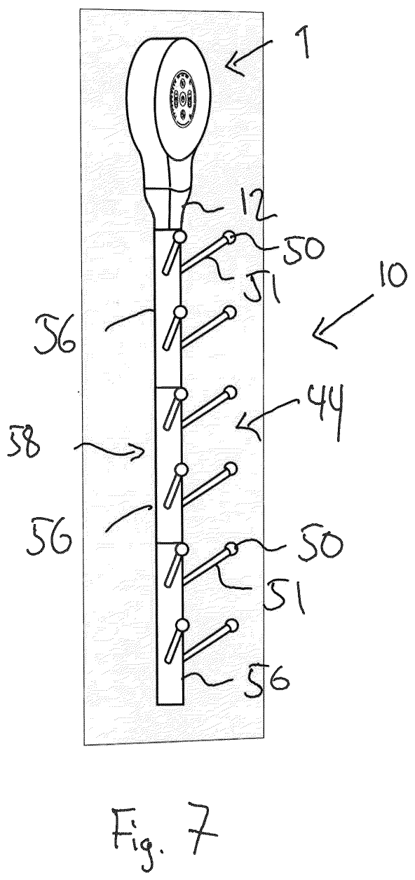

FIG. 1 shows a dryer 1. The dryer 1 comprises a housing 2 with an inlet 4, as indicated in FIG. 3, on the backside of the housing 2, and an outlet 6. The housing 2 is formed with a general circular cross-section. In the shown embodiment, the outlet 6 is provided at the top of the housing 2 in a position of use. In other embodiments, the outlet may be provided at the bottom of the housing 2, as will be shown in and discussed with reference to FIG. 7, or on one of the sides of the housing 2. In the shown embodiment, the dryer 1 includes a transition piece 12, herein the form of a nozzle, defining a transition between the housing 2 of the dryer 1 and an adapter 44 as will be shown with reference to FIGS. 3, 6-9. On a front side of the housing 2 is provided a user operable control panel 14, which is shown in an enlarged view in FIG. 2. In the shown embodiment, the control panel 14 is digital, but may in other embodiments be analogue. The control panel 14 is rotatable 180 degrees in the housing 2 so that it may be used both for hanging and standing embodiments, as will be shown with reference to e.g. FIGS. 6 and 7. The control panel 14 is connected to a control unit 48, see FIG. 3, through which the different parts of the dryer 1 may be controlled. As can be seen in the enlarged view, a main on/off switch 16 is provided to manually switch the dryer assembly 10 on/off. The airflow may be controlled by a button 18 adapted to regulate the rotational frequency of an impeller 20, such as to regulate the flow of air up to 150 m3/h, depending i.a. on the number of outlets in the adapter as will be explained in the following. In one embodiment, the impeller 20, as shown in FIG. 3, may be adjustable to operate at a rotational frequency up to 7000 rpm, preferably between 4300 to 5300 rpm and even more preferably around 4800 rpm. A timer setting button 22 may be used to set a timer for how long the dryer 1 should be operating before switching automatically off. A heat setting button 28 may be used to switch between different heat settings, such as between an output air temperature of 37, 45, or 60 degrees Celsius as explained above. The dryer 1 may also be provided with an ozonator activation button 24, for switching on/off an ozonator 40 as shown in FIG. 3. Lights 30, 32, 34 for temperature, time, and airflow, respectively, are provided to indicate the chosen values.

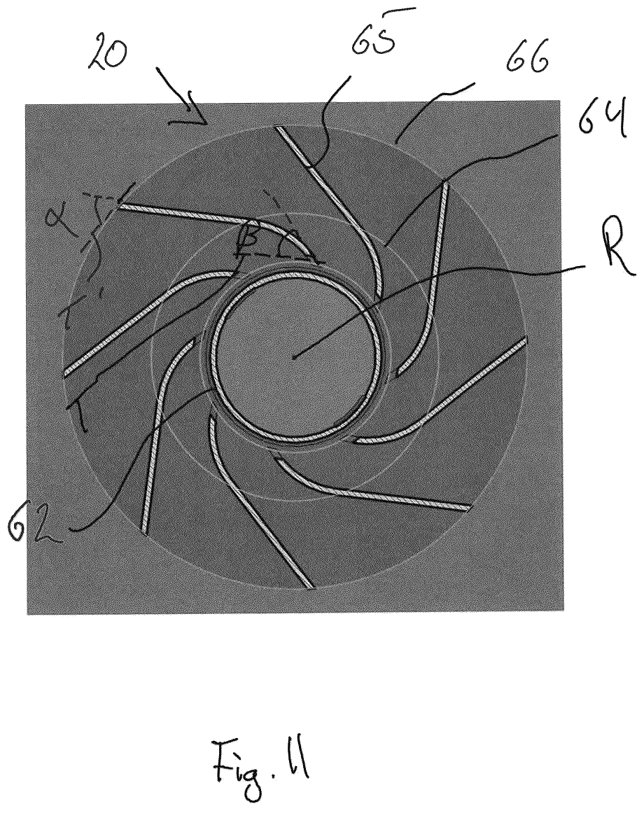

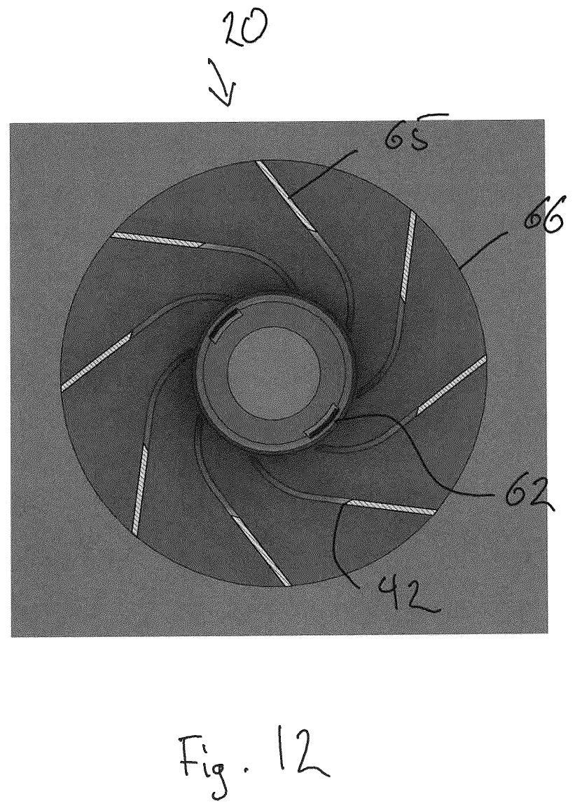

FIG. 3 shows, in a partially cut-away view, a dryer assembly 10 according to the invention. The centrifugal impeller 20 is placed slightly off-centre in the circular housing 2 of the dryer 1. The impeller 20 is rotated by means of not shown brushless DC motor via an electronic power supply 48, implying that the dryer 1 may be connected directly to a normal AC outlet in a household. The electronic power supply 48 is, in the shown embodiment, provided in a common housing 2 with the control unit. This external connection/cord is not shown in the drawing for simplicity. The inlet 4 is, as mentioned above, provided at the back of the housing 2. In the shown embodiment, the inlet 4 has a diameter of approximately 68 mm while the outer diameter of the centrifugal impeller is about 114 mm. The centrifugal impeller 20 draws in air through the inlet 4 in a direction parallel its rotational axis R and distributes the air radially out into an internal chamber 36 of the housing 2, the chamber 36 formed so as to guide the air towards the outlet 6. In the shown embodiment, the outlet 6 has a diameter of approximately 84 mm and height of 50 mm. Across the outlet 6 a ceramic heating element 38 is schematically shown. Both the inlet 4 and outlet 6 may be provided with a safety grid for child safety and/or to prevent alien objects to enter the impeller. An ozonator 40 is provided for adding small amounts of ozone to the air flowing out of the apparatus, where the ozone may inactivate bacteria, remove odour etc. The dryer may be provided with an air ioniser as an alternative or addition to the ozonator 40. The ozonator activation button 24 may be replace by an air ioniser activation button or the control panel may be provided with an addition button for activating the air ioniser. The impeller 20 includes a plurality of blades 42, the blades curving backwardly relative to the rotation of the impeller, implying that the impeller in FIG. 3 is rotating counter-clockwise. In the shown embodiment, the impeller 20 includes eight blades 42. As explained above, the backward curvature increases the pressure of the air on the outlet side, which has been found to be highly preferable for being able to “push” the air into and trough garments that are being dried. In the shown embodiment, the blades 42 are formed with an inlet angle β of 45 degrees and an outlet angle a of 55 degrees as measured relative to a tangent T of the inner and outer diameters om the impeller 20 as best seen in FIGS. 11-12. The height of the impeller is preferably in the range 32.5 mm to 47.5 mm, whereas the impeller 20 in the shown embodiment has a height of 37.5 mm. The housing 2 provides a tight fit under and above the impeller 2 and is formed with flat upper and lower surfaces for improved flow of air and noise reduction.

The dryer 1 can act as a stand-alone unit or be attached to a drying adapter 44 so as to define a dryer assembly 10 as claimed herein. The transition piece 12 may be used so that one and the same dryer 1 may be applicable for use with different adapters 44. In FIG. 3, the transition piece 12, here in the form of a nozzle, narrows the outlet cross-section from rectangular 84×50 mm to a circular diameter of about 40 mm, corresponding to a central flow path 46 of the adapter 44, which is only partially shown in FIG. 3. The adapter 44, as will become clearer with reference to FIGS. 6 and 7, has a tree-like structure. Outlets 50 on the adapter, herein the form and branches 51 on the tree, has a diameter of about 10 mm. The diameter ratio of about 4/1 between the trunk 46 and the branches 51/outlets 50 ensures that the pressure drop into the branches is not too high at the bottom of the tree, while the resistance is sufficiently low to avoid undesired noise effects and to maintain a high throughput of air. In experiments, the present applicant has found that a flow of air of 10-14 m3/h per outlet 50 in the adapter 44, preferably around 12 m3/h per outlet 50, provides a high drying efficiency when combined with a static air pressure of about 250 Pa, corresponding to a total pressure of about 300 Pa. The electronic power supply and control unit 48 is shown schematically inside the housing 2 to the upper left of the impeller 20.

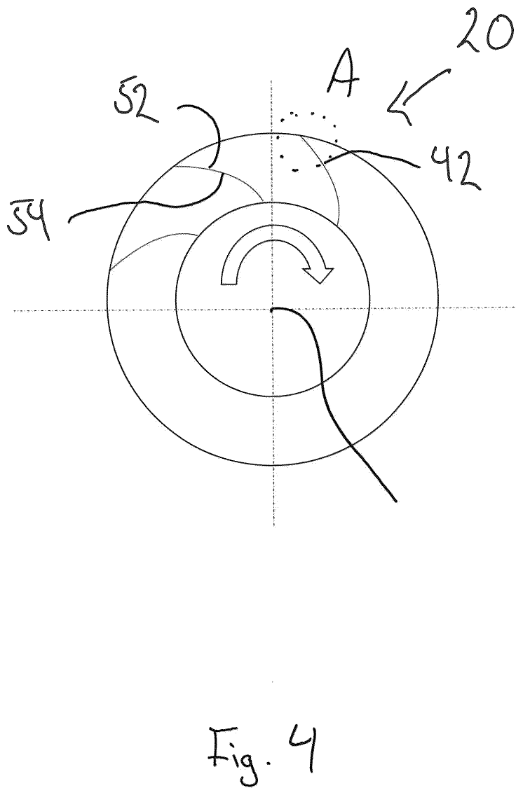

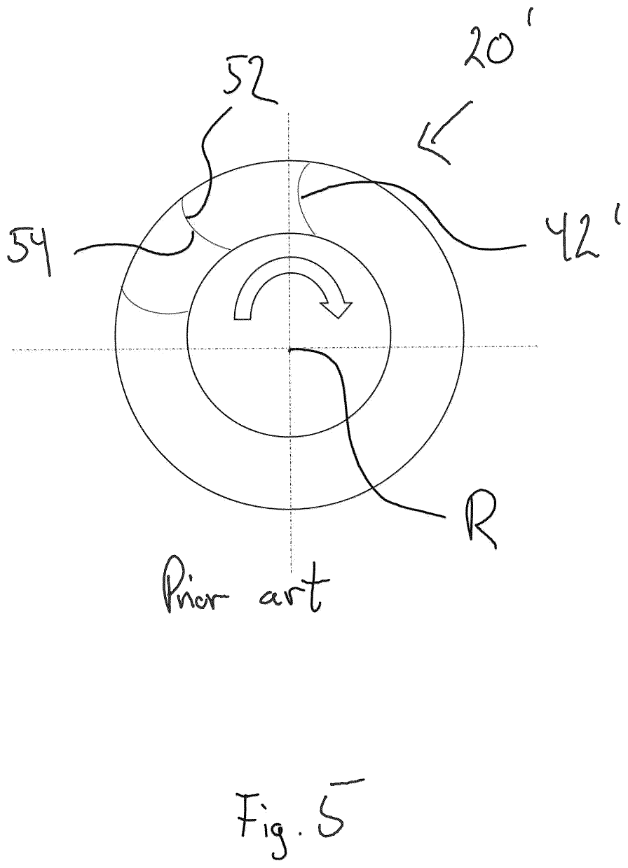

FIG. 4 shows, very schematically, the principle of backwardly curved blades 42. where the blades curve away from a pressure side 52 towards a suction side 54 of the blades. The backwardly curved blades 42 are curved backwards from the inner to outer edge, relative to the direction of motion. A pressure side 52 and a suction side 54 are created when both impeller designs rotate, but it is the difference in pressure distribution of this suction and pressure side that makes a backwardly curved blade push air directly outwards/radially, allowing for pressure build-up, compared to “catapulting” it in a forward tangential direction, generating high velocities and airflows. It should be noted that the impellers shown schematically in FIGS. 4 and 5 are rotated in a clock-wise direction, i.e. opposite of the impeller 20 shown in FIG. 3.

In FIG. 6, an embodiment of a dryer assembly 10 according to the invention is shown. The dryer 1 is releasably connected, via transition piece 12, to a tree-like adapter 44. The adapter 44 is modular in the sense that it comprises three individual adapter units 56 assembled together, where each of the adapter units 56 is formed with a central trunk unit 58 and four branches 51; two on each side. The outlets 50 are provided at distal ends of the branches 51. The three adapter units 56 together define the trunk 46/central flow portion of the adapter 44. Each trunk unit 56 and/or each branch 51 may be provided with a not shown valve to optimize air consumption and flow in case all branches/outlets are not in use. In the shown embodiment, the trunk 46 is formed with an internal diameter of about 40 mm, while the branches have a diameter of about 10 mm. The total flow of air is preferably about 12 m3/h per branch, which in the shown embodiment, with 12 branches, amounts to about 144 m3/h. At the top of the adapter a hook 59 is provided so that the assembly 10 may be hung freely on a wall, in a wardrobe etc. The trunk and/or branches may be made from plastics, metals wood or a combination thereof.

In FIG. 7 a similar embodiment is shown, but where the dryer 1 is connected to the adapter 44 at the bottom of the dryer 1. The assembly 10 is provided with a not shown wall mount to mount the assembly 10 permanently to a not shown wall.

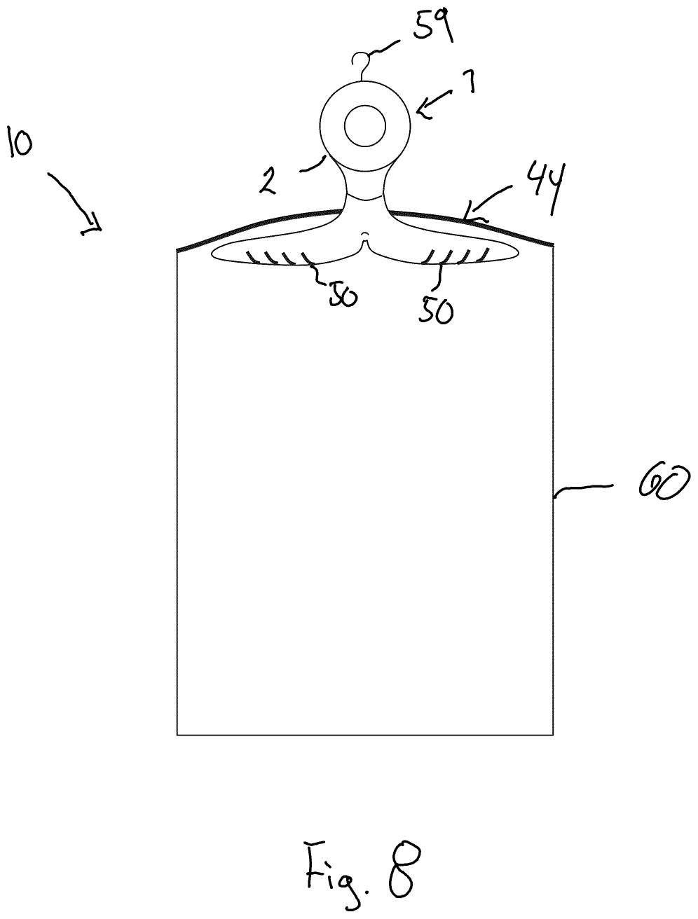

FIG. 8 shows an alternative use of dryer assembly 10 according to the invention, where the dryer 1 is releasably connected to an adapter 44 in the form of a hollow coat hanger formed with a plurality of outlets 50. Air blows from dryer 1, into the hollow coat hanger 44, out from the outlets 50 and through a not shown garment and into a storage bag 60 in which various garments may be placed/hung for quick drying. The storage bag 60 is formed will be formed with not shown holes to allow the air to flow out of it. The housing 2 of the dryer 1 is provided with a hook 59 so that the assembly 10 may be hung freely on a wall, in a wardrobe etc.

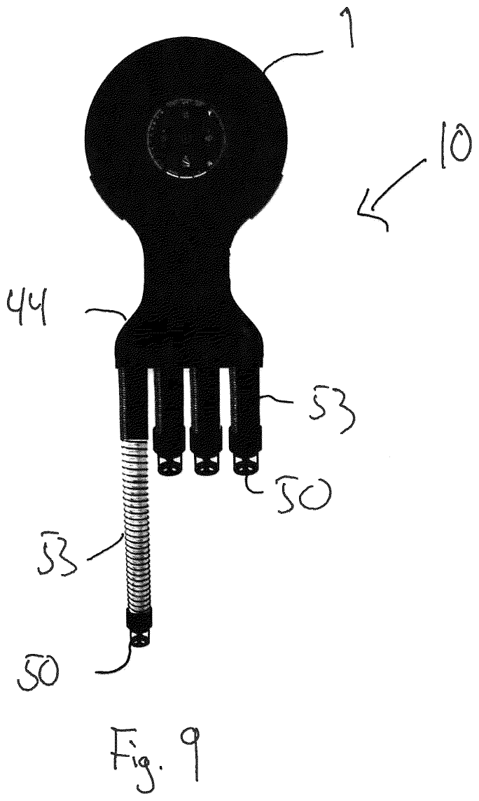

FIG. 9 shows another embodiment of a dryer assembly 10 according to the invention, where the dryer 1 is releasably connected to an adapter in the form of a hose manifold 44. In this embodiment, the air is distributed in parallel to four flexible and extendible hoses 53. The hoses 53 may in one embodiment be made from plastic or reinforced plastic, such as steel-reinforced plastic. In alternative embodiments, there may be one, two, three, five or six hoses.

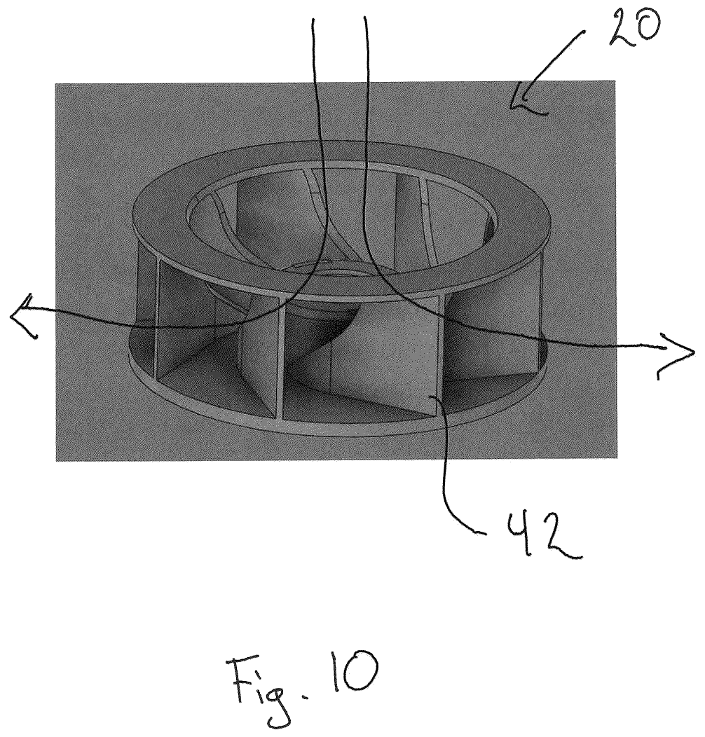

FIG. 10 shows an embodiment of an impeller 20 as used in a dryer assembly 10 according to the invention. The direction of flow of air through the impeller is indicated with arrows in the drawing. As explained herein, the blades 42 are curved backwardly relative to the rotational direction (clockwise in the shown embodiment). The blades are non-curved along the rotational/inlet/z axis and are formed with a uniform thickness.

FIGS. 11 and 12 show the impeller 20 from FIG. 10 in a top view with the upper ring removed for clarity. As can be seen, the blades 42 are connected to an inner hub 62 of the impeller 20. The angle between the blades 42 and a tangent line T at the hub 62 defines the inlet angle β. In the shown embodiment, the hub 62 is formed with a diameter of about 40 mm, and the inlet angle β is about 45 degrees. As can be seen in FIGS. 11 and 12, the blades 42 curve in the horizontal plane towards a mid-section 64 (only indicated in FIG. 11) from which the blades 42 extend in a straight portion 65 towards the outer edge/diameter 66. In the shown embodiment, this midsection 64 has a diameter of about 70 mm, whereas the outer diameter/edge 66 has a diameter of 114 mm. The outlet angle α, i.e. the angle between each of the blades 44 and tangent line T′ at the outer edge is about 55 degrees.

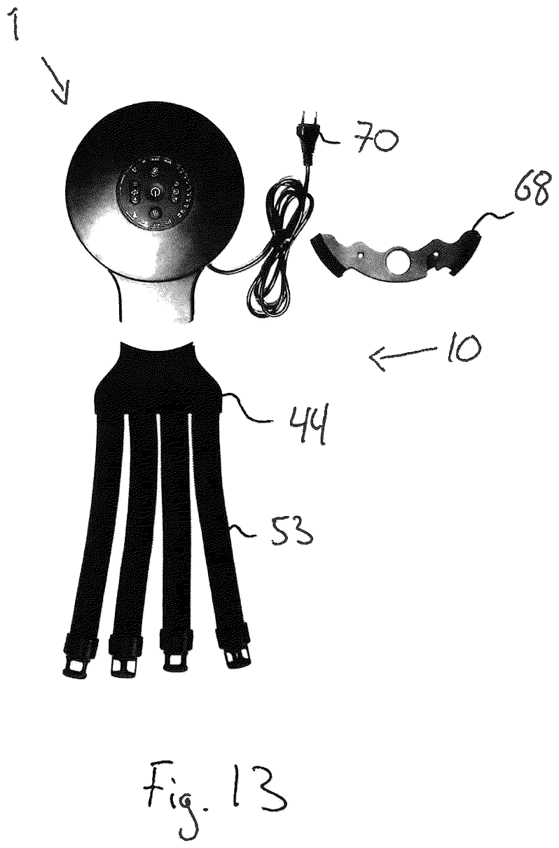

FIG. 13 shows a dryer assembly 10 similar to the one from FIG. 9 in an exploded view. A bracket 68 may be used to mount the dryer 1 to a surface, such as a wall, and a cord 70 for external connection to a household AC supply is also shown.

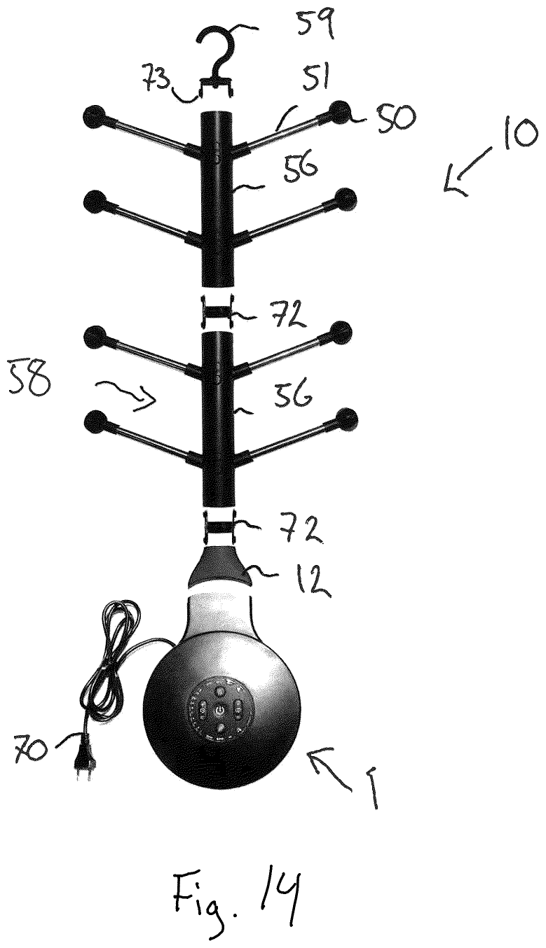

FIG. 14 shows a dryer assembly 10 similar to the one from FIG. 6 in an exploded view, though with only two adapter units 56 shown. As in FIG. 6, the adapter units include a central trunk unit 58 and four branches 51 each with outlets 50 at their distal ends. As can be seen in the drawing, the trunk units 58 connect to each other via a connector 72 in the form of a snap-lock nipple/male sleeve coupling. Similar connectors also connect the lower trunk unit 58 to the adapter 21, while a slightly different single-sided version 73 of the connector is integrated in the hook 59 for connection to the upper trunk unit 58. The connectors 72, 73 enable simple assembly/disassembly of the different parts of the adapter, as well as connection of the adapter to the housing 2 of the dryer 1, emphasizing the modularity of the dryer assemblies 10 according to the invention.

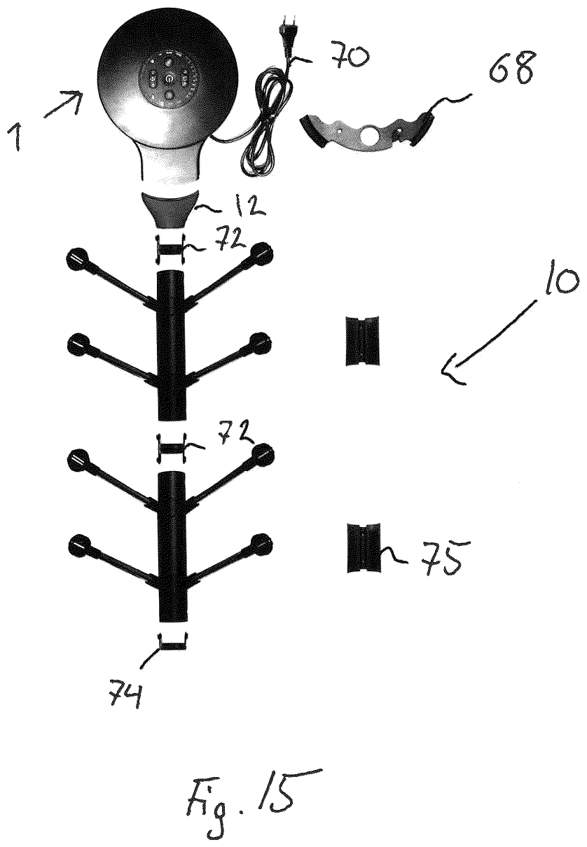

FIG. 15 shows a dryer assembly 10 similar to the one from FIG. 7 in an exploded view, though with only two adapter units 56 shown. Connectors 72 releasably connect the adapter 44, via the transition piece 12, to the upper trunk unit 58 and the trunk units 58 to each other. The lower end of the lower trunk unit 58 is blinded by an end cap/single sided connector 74. The dryer may be supported/hung off in a wall-mountable bracket 68, while an additional wall-mountable support member 75 may be used to provided additional support to the adapter units 56 on a wall.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A dryer assembly for drying garments, the dryer assembly comprising:
a housing with an air inlet and an outlet;
a centrifugal impeller for generating a flow of air from the inlet to the outlet, the centrifugal impeller having backwardly curved blades and being adapted to draw in air through the inlet in a direction parallel its rotational axis and to distribute the air radially out into an internal chamber of the housing, the chamber being formed so as to guide the air radially from the impeller towards the outlet,
a control unit adapted to control the impeller based on input from a user; and
an adapter having an inlet connected to the outlet of the housing and one or more outlets through which air from the dryer housing may flow to dry garment placed around, at or near the outlet, the adapter being releasably connected to the housing.

2. The dryer assembly according to claim 1, wherein the housing comprises a ceramic heating element provided between the inlet and the outlet, the ceramic heating element preferably being adjustable between two or more different heating temperatures, wherein the control unit is also adapted to control the ceramic heating element based on input from the user.

3. The dryer assembly according to claim 1, the housing further comprising an air ioniser provided between the inlet and the outlet.

4. The dryer assembly according to claim 1, wherein the impeller is connected to a brushless DC motor operable via an electronic power supply.

5. The dryer assembly according to claim 1, where the dryer assembly is adapted to generate an outlet airflow up to 150 m3/h, preferably between 50-120 m3/h and even more preferably around 100 m3/h.

6. The dryer assembly according to claim 1, wherein the housing is formed with an outlet with a diameter of 30-50 mm, preferably around 40 mm or where the housing is connected to the adapter via a transition piece narrowing the outlet down to a diameter of 30-50 mm, preferably around 40 mm.

7. The dryer assembly according to claim 1, wherein the impeller is adapted to operate at an efficiency between 10-25 W, preferably 15-20 W.

8. The dryer assembly according to claim 1, wherein inlet diameter is 48-88 mm, preferably around 68 mm.

9. The dryer assembly according to claim 1, wherein the outlet has a width of 64-104 mm, preferably around 84 mm and a height of 40-60 mm, preferably around 50 mm.

10. The dryer assembly according to claim 1, wherein the impeller blades are formed with an inlet angle (β) of 40-50 degrees, preferably around 45 degrees, and an outlet angle (α) of 45-65 degrees, preferably around 55 degrees.

11. The dryer assembly according to claim 1, wherein the impeller has a heigh of 27.5 mm to 47.5 mm, preferably around 37.5 mm.

12. The dryer assembly according to claim 11, wherein the adapter is a tree-like structure where the one or more outlets are defined by the branches of the tree-like structure.

13. The dryer assembly according to claim 12, wherein the trunk of the tree-like adapter has a diameter which is 3-5 times, preferably about 4 times, that of the branches.

14. The dryer assembly according to claim 13, wherein the trunk of the tree-like adapter has a diameter of about 40 mm and where the branches have a diameter of about 10 mm.

15. The dryer assembly according to claim 1, wherein the adapter is formed as a coat hanger.
